(19) United States
(12) Patent Application Publication
(10) Pub. No.: US 2005/0033013 A1
(43) Pub. Date: Feb. 10, 2005

(54) Propylene-containing composition

(76) Inventors: Cornelis F. Van Egmond, Pasadena, TX (US); Nicolas P. Coute, Houston, TX (US); Jaimes Sher, Houston, TX (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 10/635,401

(22) Filed: Aug. 6, 2003

(51) Int. Cl. C08G 67/02

(52) U.S. Cl. 528/392

(57) ABSTRACT

The present invention provides a new propylene-containing compositions, which preferably are suitable for polymerization disposition. The propylene-containing compositions include propylene, propane, dimethyl ether and one or more of ethylene, ethane, methanol, acetylene, methyl acetylene, propadiene, C4+ hydrocarbons and water. The propylene-containing composition can be derived from an oxygenate to olefin reaction system without expending resources on propane/propylene separation.

### FIELD OF THE INVENTION

The present invention relates to a propylene-containing composition. More particularly, the present invention relates to a propylene-containing composition, preferably suitable for polymerization, which includes propylene, propane, dimethyl ether and one or more of ethylene, ethane, methanol, acetylene, methyl acetylene, propadiene, C4+ hydrocarbons and water.

### BACKGROUND OF THE INVENTION

Propylene is an important commodity petrochemicals useful in a variety of processes for making plastics and other chemical compounds. For example, propylene is used to make various polypropylene plastics, and in making other chemicals such as acrylonitrile and propylene oxide.

The petrochemical industry has known for some time that oxygenates, especially alcohols, are convertible into light olefins, such as propylene. The preferred conversion process is generally referred to as an oxygenate-to-olefin (OTO) or specifically as a methanol-to-olefins (MTO) process, where methanol is converted to primarily ethylene and/or propylene in the presence of a molecular sieve catalyst.

Various byproducts are produced in the OTO reaction process. Some of these byproducts should be separated from the propylene product in order to provide propylene suitable for polymerization disposition. These byproducts may include components that are heavier than propane and propylene, such as C4+ components (olefinic and aliphatic) as well as multiply unsaturated components such as acetylene, methyl acetylene and propadiene.

Additionally, oxygenate compounds such as alcohols, aldehydes, ketones, esters, acids and ethers (particularly dimethyl ether “DME”) in the C1 to C6 range as well as trace quantities of aromatic compounds may be formed in OTO reactors or in OTO effluent processing. A small amount of oxygenate from the feedstock, e.g., methanol and/or DME, can pass through the OTO reactor with the product effluent without being converted to the desired product. As a result of oxygenate synthesis and/or incomplete oxygenate conversion in an OTO reactor system, an effluent from an OTO reactor can contain undesirably high concentrations of oxygenate compounds. These oxygenates, particularly light oxygenates, are in amounts that would make the ethylene and propylene off-specification for their preferred dispositions, e.g., polymerization.

Conventional propylene production facilities that produce propylene for polymerization disposition are required by the industry to produce very pure propylene. Conventional polymerization grade propylene contains at least 95.5 weight percent propylene, with the balance being mostly propane. A minor amount of other contaminants such as hydrogen, oxygen, and water, typically on a wppm level, may be tolerated in polymerization grade propylene. The high purity requirements in the industry are directly related to the usage of high activity catalysts for the formation of polypropylene. For example, bulk ligand metallocene-type catalyst systems such as those described in, for example, U.S. Pat. No. 5,324,800, are highly sensitive to oxygen, ethers, ketones, aldehydes, carbon dioxide, and other contaminants.

As a result of the high purity propylene requirements, various processing schemes have been developed for separating one or more contaminants from propylene-containing effluent streams. For example, U.S. Pat. No. 6,121,503 to Janssen et al., the entirety of which is incorporated herein by reference, discloses a process for converting an oxygenate feed to high purity olefins such as polymer-grade propylene.

The equipment count and resources necessary for processing crude propylene product streams and for providing high purity polymerization grade propylene can substantially increase operating costs. Thus, the need exists for providing a propylene-containing composition at a reduced cost, which may contain impurities of types and at levels that will not be prohibitive to polymerization disposition.

### SUMMARY OF THE INVENTION

The present invention provides new propylene-containing compositions, which preferably are suitable for polymerization. The propylene-containing compositions preferably are derived from an oxygenate to olefin (OTO) reaction system, preferably from a methanol to olefin (MTO) reaction system. The OTO reaction system preferably forms an initial effluent stream, which is directed to an effluent processing system, provided to separate components contained in the initial effluent stream. The propylene-containing composition of the present invention beneficially can be derived from an effluent processing system which lacks a C3 splitter. By providing a propylene-containing composition, which is suitable for polymerization, without implementing a C3 splitter, equipment count can be advantageously reduced. As a result, propylene and polypropylene production costs can be significantly decreased over conventional propylene-forming systems.

In one embodiment, the propylene-containing composition of the present invention comprises at least 95 volume percent propylene, at least 0.5 volume percent propane, at least 10 vppm ethane, at least 1 vppm ethylene, and from 0.5 to 2 vppm dimethyl ether. It has been discovered that the dimethyl ether content of the claimed propylene-containing composition is not significantly detrimental to most polymerization catalysts.

Optionally, the propylene-containing composition includes additional contaminants. A non-limiting list of additional possible contaminants that may be present in the propylene-containing composition of the present invention, individually or collectively, includes: acetylene, methyl acetylene, propadiene, C4+ hydrocarbons, methanol, water and hydrogen. Specifically, the propylene-containing composition of the present invention optionally comprises at least 0.05 vppm acetylene, or from 1 to 2 vppm acetylene. Optionally, the propylene-containing composition further comprises at least 0.01 vppm methyl acetylene, or from 1 to 3 vppm methyl acetylene. Optionally, the propylene-containing composition further comprises at least 0.01 vppm propadiene, or from 1 to 3 vppm propadiene. Optionally, the propylene-containing composition further comprises at least 0.02 vppm C4+ hydrocarbons, or from 5 to 15 vppm C4+ hydrocarbons. Optionally, the propylene-containing composition further comprises at least 0.01 vppm methanol, or from 0.5 to 1 vppm methanol. Optionally, the propylene containing composition further comprises at least 0.01 vppm water, or from 1 to 5 vppm water. Optionally, the propylene-containing composition further comprises at least 0.01 vppm hydrogen, or from 5 to 20 vppm hydrogen. Optionally, the propylene-containing composition comprises from 0.5 to 2 vppm methanol. Optionally, the propylene-containing composition comprises from 2 to about 5 volume percent propane. Optionally, the propylene-containing composition comprises from 300 to 1,000 vppm ethane. Optionally, the propylene-containing composition comprises from 5 to 15 vppm ethylene. Optionally, the propylene-containing composition comprises from 0.5 to 1 vppm dimethyl ether, or from 1 to 2 vppm dimethyl ether. Preferably, the propylene-containing composition is depleted, or substantially depleted, of arsine and phosphine. In one embodiment, the propylene-containing composition comprises less than 0.01 vppm arsine, preferably less than 0.001 vppm arsine. Preferably, the propylene-containing composition comprises less than 0.01 vppm phosphine, more preferably less than 0.001 vppm phosphine.

In another embodiment of the present invention, the propylene-containing composition comprises at least 95 volume percent propylene, from 0.5 to about 5 volume percent propane, at least 0.02 vppm C4+ hydrocarbons, at least 0.01 vppm methanol, and from 0.5 vppm to 2 vppm dimethyl ether. Optionally, the propylene-containing composition of this embodiment further comprises one or more of ethane, ethylene, propane, arsine, phosphine, acetylene, methyl acetylene, water, hydrogen and/or propadiene, optionally in the amounts provided in the above ranges.

In another embodiment, the present invention provides a propylene-containing composition comprising at least 95 volume percent propylene, from 0.5 to 5 volume percent propane, at least 10 vppm ethane, at least 0.05 vppm acetylene, and from 0.5 to 2 vppm dimethyl ether. Optionally, the propylene-containing composition of this embodiment further comprises one or more of ethylene, C4+ hydrocarbons, methanol, arsine, phosphine, methyl acetylene, water, hydrogen and/or propadiene, optionally in the amounts provided in the above ranges.

In another embodiment, the present invention is directed to a propylene-containing composition comprising at least 95 volume percent propylene, from 0.5 to about 5 volume percent propylene, at least 10 vppm ethane, at least 0.02 vppm C4+ hydrocarbons, and from 0.5 to 2 vppm dimethyl ether. Optionally, the propylene-containing composition of this embodiment further comprises one or more of ethylene, acetylene, methanol, arsine, phosphine, methyl acetylene, water, hydrogen and/or propadiene, optionally in the amounts provided in the above ranges.

In another embodiment, the present invention is directed to a propylene-containing composition comprising at least 95 volume percent propylene, from 0.5 to 5 volume percent propane, at least 0.1 vppm water, at least 0.01 vppm methanol, and from 0.5 to 2 vppm dimethyl ether. Optionally, the propylene-containing composition of this embodiment further comprises one or more of ethane, ethylene, C4+ hydrocarbons, acetylene, arsine, phosphine, methyl acetylene, hydrogen and/or propadiene, optionally in the amounts provided in the above ranges.

In another embodiment, the present invention is directed to a propylene-containing composition, wherein the composition is formed by a specified process. The process preferably includes a step of contacting an oxygenate with a molecular sieve catalyst in a reactor under conditions effective to form an effluent stream comprising propylene, propane, ethylene, dimethyl ether and ethane. The effluent stream is separated in a first separation unit into a first fraction and a second fraction. The first fraction contains a majority of the ethane, ethylene and propylene, and the second fraction contains a majority of the dimethyl ether. At least a portion of the first fraction is separated into a third fraction and the propylene-containing composition. The third fraction contains the majority of the ethylene and ethane in the at least a portion of the first fraction. The propylene-containing composition comprises at least 95 volume percent propylene, at least 0.5 volume percent propane, at least 10 vppm ethane, at least 1 vppm ethylene and from 0.5 to 2 vppm dimethyl ether. In this embodiment, the conditions in the contacting step optionally provide for 95 to 97 weight percent conversion of the oxygenate, based on the total weight of the oxygenate fed to the reactor. The contacting optionally occurs at a pressure of at least 150 psig, a pressure of from 150 to 370 psig, or a pressure of from 250 to 370 psig. The molecular sieve catalyst optionally comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

In another embodiment, the present invention is directed to a propylene-containing composition, which is formed by a process comprising an initial C2/C3 separation step. This process also comprises a step of contacting an oxygenate with a molecular sieve catalyst in a reactor under conditions effective to form an effluent stream comprising propylene, propane, ethylene, DME and ethane. The effluent stream is separated in a first separation unit into a first fraction and a second fraction. In this process, the first fraction contains a majority of the ethane and ethylene and, the second fraction contains a majority of the DME, propane and propylene. At least a portion of the second fraction is separated into the propylene-containing composition and a third fraction. In this embodiment, the propylene-containing composition comprises at least 95 volume percent propylene, at least 0.5 volume percent propane, at least 10 vppm ethane, at least 1 vppm ethylene, and from 0.5 to 2 vppm DME. The third fraction contains a majority of the propane and DME present in the at least a portion of the second fraction.

### BRIEF DESCRIPTION OF THE DRAWINGS

This invention will be better understood by reference to the Detailed Description of the Invention when taken together with the attached drawings, wherein:

FIG. 1 illustrates a separation scheme for forming a propylene-containing composition according to one embodiment of the present invention;

FIG. 2 illustrates a separation scheme for forming a propylene-containing composition according to another embodiment of the present invention; and

FIG. 3 illustrates an oxygenate to olefin reaction unit and an initial processing scheme.

### DETAILED DESCRIPTION OF THE INVENTION

Introduction

The present invention provides novel propylene-containing compositions, which are preferably suitable for polymerization. The inventive propylene-containing compositions ideally are formed through new highly efficient separation processes and systems for separating the propylene-containing composition from an “initial effluent stream,” defined herein as a stream comprising dimethyl ether (DME), ethane, ethylene and propylene. Specifically, these processes remove some, but not all, of the DME from the initial effluent stream. Ideally, the amount of residual DME contained in the resulting propylene-containing composition is not prohibitive to polymerization disposition of the propylene-containing composition. Additionally, the initial effluent stream optionally includes one or more of propane, acetylene, methyl acetylene, propane, methane, hydrogen, carbon monoxide, carbon dioxide, and C4+ components (aliphatic and/or olefinic). In a particularly preferred embodiment, the initial effluent stream is derived from the product effluent of an oxygenate to olefin (OTO) reaction process, described in detail below. One significant advantage of the present invention is that the amounts of DME present in the claimed propylene-containing composition can be more efficiently removed in the polymerization facility, e.g., after polymerization, than in an OTO reaction system.

The Initial Effluent Stream

The initial effluent stream may be derived from a variety of sources. For example, in one embodiment, the initial effluent stream is derived from a product effluent of a reaction selected from the group consisting of an olefin interconversion reaction, an OTO reaction, an oxygenate to gasoline conversion reaction, malaeic anhydride formulation, vapor phase methanol synthesis, phthalic anhydride formulation, a Fischer Tropsch reaction, and an acrylonitrile formulation. Preferably, the initial effluent stream is derived from an effluent stream of a methanol to olefin (MTO) reaction system.

Although the initial effluent stream can be derived from any conventional source that contains ethane, ethylene, propylene and DME, the invention is particularly suited to removing DME and other oxygenates from an initial effluent stream derived from an OTO process or, particularly, from an MTO process. Thus, in one embodiment of this invention, an initial effluent stream containing DME is derived from a product effluent stream of a reaction system, wherein an oxygenate feedstock contacts a molecular sieve catalyst under conditions effective to form light olefins, as described in more detail below.

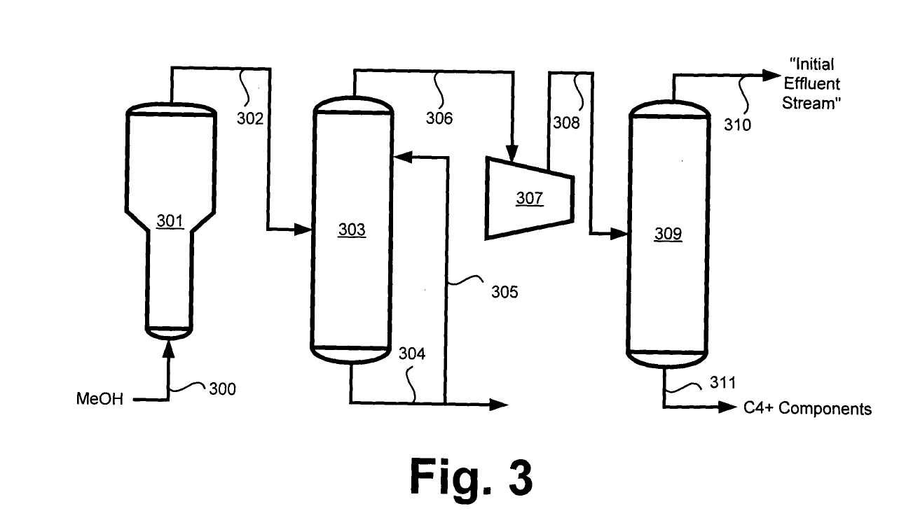

An MTO reaction system produces a product effluent stream, which includes a minor amount of C4+ components (olefin and aliphatic) in addition to ethane, ethylene, DME, propane and propylene. The product effluent also may include one or more of hydrogen, methane, carbon monoxide, carbon dioxide, acetylene, methyl acetylene and propadiene. One non-limiting system for forming the initial effluent stream from an MTO reaction system is discussed in more detail below with reference to FIG. 3.

FIG. 3 illustrates one process for deriving an initial effluent stream containing ethane, ethylene, DME and propylene, and optionally C4+ components from an MTO reaction system. In FIG. 3, methanol is sent through line 300 to an MTO reactor 301 wherein the methanol is converted to light olefins, which exit the MTO reactor 301 in olefin-containing stream 302. Light olefin-containing stream 302 comprises methane, ethylene, ethane, propylene, propane, DME, water, a minor amount of C4+ components, and other hydrocarbon and oxygenate components. The olefin-containing stream 302 is directed to a quench tower 303 wherein the olefin-containing stream 302 is cooled and water and other readily condensable components are condensed.

The condensed components, which comprise a substantial amount of water, are withdrawn from the quench tower 303 through a bottoms line 304. A portion of the condensed components are circulated through line 305 back to the top of the quench tower 303. The line 305 contains a cooling unit, e.g., heat exchanger, not shown, to cool the condensed components so as to provide a cooling medium to cool the components in quench tower 303.

Olefin-containing vapor is yielded from the quench tower 303 through a quench overhead stream 306. The olefin-containing vapor is compressed in one or more compressors 307 to form a compressed stream 308. As shown, the compressed stream 308 is directed to a C4+ component removal unit 309, e.g., a depropanizer, prior to light ends separation or C2/C3 separation. The C4+ components typically contain foulants such as butadiene. As a result, the C4+ components preferably are removed after product quenching and compression, but before removal of light ends, before C2/C3 separation, before any optional washing steps, and before removal of the other components contained in the initial effluent stream. It is contemplated, however, as described in detail below, that the C4+ component removal unit 309 optionally may be disposed in the downstream separation and processing system according to several alternative embodiments for forming the propylene-containing composition of the present invention. Reverting to FIG. 3, in the C4+ component removal unit 309, the compressed stream 308 is subjected to conditions, e.g., temperature and pressure, sufficient to separate the compressed stream 308 into a C3− stream 310, e.g., the initial effluent stream, and a C4+stream 311. The C3− stream 310 contains a majority of the C3− components, e.g., light ends, ethane, ethylene, propane, DME and propylene, present in the compressed stream 308, while the C4+ stream 311 contains a majority of the C4+ components, e.g., butane, butylene, butadiene, pentanes and heavier components, present in the compressed stream 308.

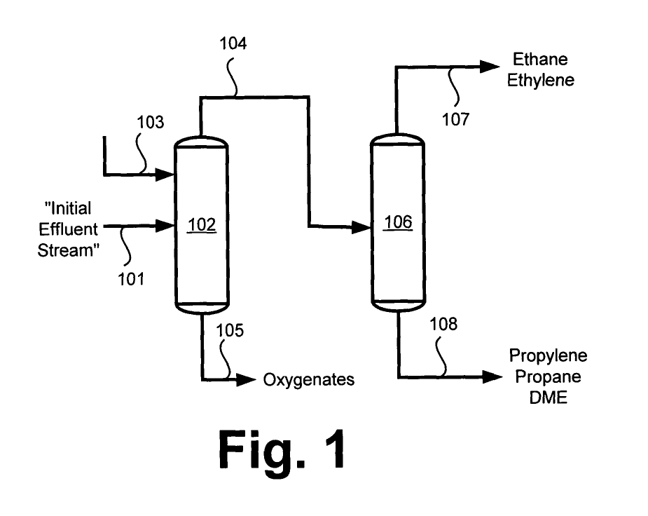

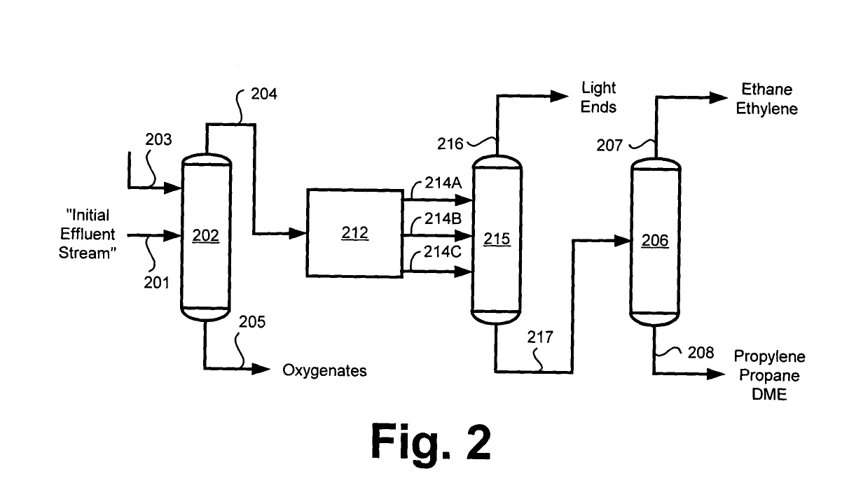

As indicated above, “initial effluent stream,” is defined herein as a stream comprising dimethyl ether (DME), ethane, ethylene and propylene. Thus any of the following streams can be characterized as the initial effluent stream according to the present invention: the olefin-containing stream 302, quench overhead stream 306, compressed stream 308 or C3− stream 310. That is, any of these streams, preferably compressed stream 308 or C3− stream 310, optionally is the initial effluent stream 100/200 that is directed to the first separation unit 101/201 and processed as shown in FIG. 1 and FIG. 2, and as described in detail below.

The composition of the initial effluent stream will now be described. The initial effluent stream contains ethane, ethylene, propylene and DME. In one embodiment of the exemplary separation process, the initial effluent stream that is provided comprises not greater than about 50 weight percent DME, not greater than about 20 weight percent DME, not greater than about 10 weight percent DME, or not greater than about 5 weight percent DME. Of course, for DME to be partially removed from the initial effluent stream, some measurable amount must be present. Optionally, the provided initial effluent stream contains at least about 100 wppm DME, at least about 500 wppm DME, or at least about 1,000 wppm DME. If the initial effluent stream is derived from an OTO or MTO reaction system, the DME concentration in the initial effluent stream may be considerably higher, particularly if the OTO reaction system operates at an oxygenate conversion percentage of between about 93 weight percent and about 96 weight percent, based on the total weight of the oxygenate fed to the hydrocarbon conversion apparatus. In this embodiment, the initial effluent stream optionally contains more than 1000 wppm, more than 1500 wppm, more than 3000 wppm or more than 6000 wppm DME. DME levels optionally can be greater than 1.0, 2.0 or 3.0 weight percent DME, based on the total weight of the initial effluent stream. As used herein, “weight percent,” “wppm” and “wppb” are based on the total weight of all components in a specified stream. Similarly, “volume percent,” “vppm” and “vppb” are based on the total volume of all components in a specified stream.

In another embodiment, the initial effluent stream that is provided comprises at least about 25 weight percent ethylene. Preferably, the provided initial effluent stream comprises from about 25 weight percent ethylene to about 75 weight percent ethylene, more preferably from about 30 weight percent to about 60 weight percent, and most preferably from about 35 weight percent to about 50 weight percent ethylene. In terms of lower range limitations, the initial effluent stream optionally comprises at least about 5 weight percent, at least about 10 weight percent, or at least about 20 weight percent ethylene.

In another embodiment, the initial effluent stream that is provided also comprises at least about 20 weight percent propylene. Preferably, the provided initial effluent stream comprises from about 20 weight percent propylene to about 70 weight percent propylene, more preferably from about 25 weight percent to about 50 weight percent propylene, and most preferably from about 30 weight percent to about 40 weight percent propylene. In terms of lower range limitations, the initial effluent stream preferably comprises at least about 5 weight percent, more preferably at least about 10 weight percent, and most preferably at least about 15 weight percent propylene.

In another embodiment, the initial effluent stream contains both ethylene and propylene. Desirably, the initial effluent stream contains at least about 50 weight percent ethylene and propylene. Preferably, the initial effluent stream contains from about 50 weight percent to about 95 weight percent ethylene and propylene, more preferably from about 55 weight percent to about 90 weight percent ethylene and propylene, and most preferably from about 60 weight percent to about 85 weight percent ethylene and propylene.

It is desirable that the provided initial effluent stream contains a relatively low concentration of ethane, preferably a lower concentration of ethane than propane. Preferably, the initial effluent stream comprises not greater than about 4 weight percent ethane, more preferably not greater than about 3 weight percent ethane, and most preferably not greater than about 2 weight percent ethane. In terms of lower range limitations, the initial effluent stream comprises at least about 0.1 weight percent, at least about 0.5 weight percent, or at least about 1.0 weight percent ethane.

It is also desirable that the initial effluent stream contains a relatively low concentration of propane, if any. Preferably, the initial effluent stream comprises not greater than about 5 weight percent propane, not greater than about 4 weight percent propane, or not greater than about 3 weight percent propane. In terms of lower range limitations, the initial effluent stream optionally contains at least about 0.1 weight percent, at least about 0.5 weight percent, or at least about 1.0 weight percent propane.

The initial effluent stream also optionally contains one or more of acetylene, and C4+ components. If the initial effluent stream contains acetylene, the initial effluent stream optionally contains less than about 150 wppm, less than 100 wppm, less than 50 wppm, less than about 10 wppm, or less than about 1.0 wppm acetylene. In terms of lower range limitations, the initial effluent stream optionally contains at least about 0.1 wppm, at least about 0.5 wppm, or at least about 1.0 wppm acetylene. The initial effluent stream to be processed according to the present invention optionally is depleted in C4+ hydrocarbons and C4+ olefins (C4+ components, collectively). The initial effluent stream preferably contains less than about 30 weight percent, more preferably less than about 20 weight percent, and most preferably less than about 15 weight percent C4+ components. In terms of lower range limitations, the initial effluent stream optionally contains at least about 1 weight percent, at least about 5 weight percent, or at least about 10 weight percent C4+ components. The initial effluent stream optionally contains less than about 10 weight percent, less than about 5 weight percent, or less than about 1 weight percent C4+ olefins. The initial effluent stream optionally contains less than about 1.0 weight percent, less than about 0.5 weight percent, or less than about 0.1 weight percent C4+ hydrocarbons.

Additionally, the initial effluent stream may include a minor amount of other components such as methyl acetylene, propadiene, and light ends. As used herein, “light ends” means components having a normal boiling point less than about −166° F. (−110° C.) and carbon monoxide. An exemplary list of light ends includes methane, carbon monoxide and hydrogen. The initial effluent stream to be processed according to the present invention optionally contains less than about 1.0 weight percent, less than about 0.5 weight percent, or less than about 0.01 weight percent light ends. The initial effluent stream optionally contains less than about 1.0 weight percent, less than about 0.5 weight percent, or less than about 0.1 weight percent methane. In terms of lower range limitations, the initial effluent stream optionally contains at least about 0.001 weight percent, at least 0.005 weight percent, at least 0.01 or at least 0.10 weight percent light ends. The initial effluent stream optionally contains at least about 0.001 weight percent, at least 0.005 weight percent, at least 0.01 or at least 0.10 weight percent methane. The initial effluent stream optionally contains less than about 0.01 weight percent, less than about 0.005 weight percent, or less than about 0.001 weight percent carbon monoxide. In terms of lower range limitations, the initial effluent stream optionally contains at least about 0.0001 weight percent, at least 0.0005 weight percent, at least about 0.001 or at least about 0.01 weight percent carbon monoxide.

The provided initial effluent stream can also contain some amount of water. Water that is present in the provided initial effluent stream should be at a concentration sufficiently low such that a separate water phase is not formed during the separation process. This is particularly important when a distillation column having trays is used in the inventive process, since a separate water phase formed in the trays will impede mass transfer and add extra weight to each tray. Distillation columns having packing are preferred at higher concentrations of water, since such a column will not have trays to hold up separate water phases.

The initial effluent stream can contain some water. Optionally, the provided initial effluent stream contains not greater than about 15,000 wppm water, not greater than about 10,000 wppm water, not greater than 5,000 wppm water, or not greater than about 1,000 wppm water. The initial effluent stream optionally contains at least about 10 wppm water, at least about 20 wppm water, at least about 25 wppm water, at least about 100 wppm water, or at least about 200 wppm water.

The First Separation Unit

As indicated above, the propylene-containing composition of the present invention is derived from an initial effluent stream, which preferably is processed in an effluent processing system to form the propylene-containint composition. A preferred effluent processing system will now be described.

In one embodiment, the effluent processing system comprises a first separation unit adapted to remove some oxygenate from the initial effluent stream. Specifically, a first stream, e.g., the initial effluent stream, comprising DME, ethane, ethylene and propylene is directed to the first separation unit. The first separation unit preferably includes one or more distillation and/or fractionation columns, absorbers and/or extractive distillation columns that are designed to form one or more overhead streams comprising the ethane, ethylene, propylene, and optionally propane and/or acetylene, and one or more bottoms streams comprising a portion of the DME. The first separation unit preferably subjects the first stream to conditions, e.g., temperature and pressure, that are effective to separate the first stream into a first fraction and a second fraction. The term “fraction,” as used herein, is not limited to a stream that is formed by a fractionation or distillation process, and any of a number of known separation processes may be used to form the fractions according to the present invention. Furthermore, it is to be understood that a side draw stream optionally may be implemented in a separation unit when reference is made herein to an overhead or bottoms stream.

The first fraction, which preferably is an overhead fraction, contains a majority of the ethane, ethylene and propylene, individually or collectively, that was present in the first stream. More preferably, the first fraction comprises at least about 60 weight percent, more preferably at least about 75 weight percent, and most preferably at least about 90 weight percent of the ethane, ethylene and propylene, individually or collectively, that was present in the first stream.

If the first stream includes propane, then the first fraction optionally contains a majority of the propane that was present in the first stream. More specifically, in one embodiment, the first fraction comprises at least about 60 weight percent, more preferably at least about 75 weight percent, and most preferably at least about 90 weight percent of the propane that was present in the first stream. If the first stream includes acetylene, then the first fraction preferably contains a majority of the acetylene that was present in the first stream. More preferably, the first fraction comprises at least about 60 weight percent, more preferably at least about 75 weight percent, and most preferably at least about 90 weight percent of the acetylene that was present in the first stream.

In one embodiment, the invention includes removing oxygenated components such as methanol and some of the DME from the initial effluent stream in the first separation unit. This embodiment is particularly beneficial for removing DME from an ethylene and/or propylene containing stream so that the ethylene and/or propylene can be polymerized without poisoning catalyst used in the polymerization reaction. Preferably, this separation step occurs in the first separation unit. Additionally or alternatively, however, further removal of these or other light oxygenates may occur in additional downstream separation steps. The recovered light oxygenates optionally are recycled as feedstock to the MTO reactor.

In one embodiment, the second fraction, which preferably is a bottoms stream, contains a majority of the DME that was present in the first stream. Optionally, at least about 75 weight percent of the DME in the provided initial effluent stream will be separated out in the second fraction. Preferably, at least about 85 weight percent of the DME in the provided olefin stream will be separated out in the second fraction, more preferably at least about 95 weight percent, and most preferably at least about 99 weight percent.

The second fraction may also contain some propane from the first stream. Depending on the design of the first separation unit, the second fraction optionally contains less than about 50 weight percent, more preferably less than about 35 weight percent, and most preferably less than about 25 weight percent of the propane that was present in the first stream. In terms of lower range limitations, the second fraction may include at least about 5 weight percent, more preferably at least about 10 weight percent, more preferably at least about 20, and most preferably at least about 30 weight percent of the propane that was present in the initial effluent stream. In another embodiment, the second fraction contains at least a majority of the propane that was present in the initial effluent. In this embodiment, the second fraction optionally contains at least about 60 weight percent, at least about 75 weight percent, or at least about 80 weight percent of the propane present in the initial effluent stream.

According to the present invention, oxygenated contaminants, particularly some DME, are removed from the provided initial effluent stream at low or high pressure. An advantage of using a low pressure separation is that lower temperatures can be obtained in the heavier fractions separated during the separation process. A benefit of lower temperatures is that there will be fewer equipment fouling problems. In addition, such a process will use a lower energy input to run associated operating equipment such as reboilers and condensers. Another advantage in low pressure separation is that less energy will be required to maintain system separation pressure. This means that compressors having fewer stages can be more readily utilized.

An advantage of using a high pressure separation is that separation of olefins can be accomplished at higher temperatures. By taking advantage of higher temperature separation, less refrigeration is required to recover lighter olefins such as ethylene and propylene. The practical result is a substantial savings in energy. Another advantage of high pressure separation is that clathrate and free water formation can be more easily controlled in the separation equipment. This is particularly advantageous when distillation columns having internal trays are used as the separation equipment, since internal trays are prone to collect water and clathrates. If an excessive amount of water and/or clathrates are collected, the trays can break apart or collapse, causing severe equipment damage.

In general, the process of separating DME from an initial effluent stream at low pressure comprises providing an initial effluent stream which contains ethylene, ethane, propylene, and DME, and separating at least a majority, i.e., greater than 50 weight percent, of the DME present in the olefin stream. The initial effluent stream can come from any conventional source. However, this process is particularly effective in separating some of the DME from effluent streams formed from an OTO reaction process, and particularly from an MTO reaction process.

The initial effluent stream preferably is separated into a first fraction and a second fraction, with a majority of ethylene and/or propylene being separated in the first fraction and a majority of the DME being separated in the second fraction. In one embodiment, the separation is carried out at a pressure of less than 200 psig (1,480 kPa absolute). Preferably, separation is carried out at a pressure of from about 100 psig (791 kPa absolute) to about 200 psig (1,480 kPa absolute), more preferably from about 120 psig (929 kPa absolute) to about 180 psig (1,342 kPa absolute).

As indicated above, the separation can also be performed at a high pressure. For example, in the high pressure separation embodiment, the initial effluent stream can be separated into a first fraction and a second fraction at a pressure of at least about 200 psig (1,480 kPa absolute). Preferably, the high pressure separation is carried out at a pressure of from about 200 psig (1,480 kPa absolute) to about 290 psig (2,100 kPa absolute), more preferably from about 250 psig (1,825 kPa absolute) to about 290 psig (2,100 kPa absolute).

In the high pressure separation embodiment, the actual upper pressure limit of the separation process will typically depend upon the temperature at which the second fraction is separated. The second fraction optionally contains DME and other hydrocarbons having boiling points higher than DME, for example C4+ components. It is desirable to keep the compounds in the second fraction sufficiently low in temperature so as not to cause chemical degradation or fouling problems in other downstream separation and treating equipment.

In another embodiment of the invention, the separation process is performed in a distillation column such that the first or overhead stream is at a temperature of not greater than about 30° F. (−1.1° C.). Preferably the first or overhead stream is at a temperature of about 0° F. (−17.8° C.) to about 30° F. (−1.1° C.), more preferably about 10° F. (−12.2° C.) to about 25° F. (−3.9° C.). In this embodiment, separation will be such that the second fraction will have an average temperature of not greater than about 250° F. (121° C.), preferably not greater than about 240° F. (116° C.), and more preferably not greater than about 230° F. (110° C.).

It is desirable in this invention that the second or bottoms fraction of the distillation column be maintained at a temperature level to reduce fouling problems. In one embodiment, the second fraction is at an average temperature of not greater than about 210° F. (99° C.), preferably not greater than about 200° F. (93° C.), and more preferably not greater than about 190° F. (88° C.).

It is further desirable in this invention that a water absorbent, as described above, be added to the first separation unit in which the separation of the oxygenated contaminants from the provided initial effluent stream is performed. The addition of water absorbent directly to the separation vessel can be of additional benefit in reducing free water and/or clathrate formation in the vessel.

In one embodiment of the invention, water absorbent is added to the oxygenate separation vessel, e.g., the first separation unit, in an amount sufficient to substantially reduce oxygenate content (e.g., DME) or clathrate formation. It is preferred that water absorbent be added to the vessel at a molar ratio of water absorbent to total olefin feed entering the separation vessel of about 4:1 to about 1:5,000. Higher molar ratios of water absorbent to total olefin feed are desirable for reducing oxygenate content; preferably from about 4:1 to about 1:1, more preferably from about 3:1 to about 1.2:1, and most preferably from about 2.5:1 to about 1.5:1. Lower molar ratios of water absorbent to total olefin feed are desirable for reducing clathrate formation; preferably from about 1:1 to about 1:5,000, more preferably from about 1:100 to about 1:4,000, and most preferably from about 1:500 to about 1:3,000.

In one embodiment of this invention, separation is by conventional distillation. Distillation is carried out using a vessel or tower having internal packing or trays that creates a temperature difference from top to bottom of the tower. The upper portion of the tower is the cooler portion, and higher volatile components in the feed exit from the top of the tower.

In this invention it is desirable to obtain high concentrations of ethylene and propylene from an initial effluent stream containing DME. The DME is partially separated from the ethylene and propylene in the initial effluent stream. In this embodiment, the ethylene and propylene and a first portion of DME are recovered in a first fraction, and a second portion of DME is recovered in a second fraction. Typically, the first fraction will be the overhead or side fraction of a distillation column, and the second fraction will be a bottoms fraction or additional side fraction of the distillation column.

In one embodiment of the invention, a majority of the ethylene and propylene in the provided initial effluent stream will be separated in a first fraction and a majority of the DME and other oxygenates in the provided olefin stream will be separated in a second fraction. Preferably, the first fraction will contain at least about 75 weight percent of the ethylene and propylene in the provided olefin stream, more preferably at least about 85 weight percent, and most preferably at least about 95 weight percent.

A majority of the propane in the provided initial effluent stream, if any, can be separated out in either the first or second fraction. If the majority of the propane is contained in the first fraction, then there will be less separation of heavier products into the second fraction. However, there can be slightly increased levels of DME in the first fraction when a majority of the propane is in the first fraction. In this embodiment, at least about 60 weight percent of the propane in the provided initial effluent stream, preferably at least about 70 weight percent, and more preferably at least about 80 weight percent will be in the first fraction, and the first fraction will contain not greater than about 50 wppm, preferably not greater than about 25 wppm, more preferably not greater than about 10 wppm DME, and most preferably not greater than about 5 wppm DME.

If a majority of the propane in the provided initial effluent stream is separated out in the second fraction, then the concentration of DME in the first fraction will be significantly lower. In this embodiment, at least about 60 weight percent of the propane in the provided olefin stream, preferably at least about 70 weight percent, and more preferably at least about 80 weight percent will be in the second fraction, and the second fraction will contain not greater than about 25 wppm, preferably not greater than about 15 wppm, more preferably not greater than about 5 wppm ether, and most preferably not greater than about 1 wppm DME.

In another embodiment of the invention, the second fraction will also contain some hydrocarbon compounds having four or more carbons. These compounds are also known as C4+ components. The amount of C4+ components in the second fraction can vary, particularly depending upon the amount of propane in the second fraction. For example, the second fraction optionally contains from about 5 weight percent to about 90 weight percent C4+ components. Preferably, the second fraction contains from about 25 weight percent to about 80 weight percent C4+ components, more preferably from about 35 weight percent to about 75 weight percent C4+ components.

It is of further advantage in this invention to operate the separation vessel, e.g., the first separation unit, at a temperature and pressure to separate out of the provided initial effluent stream at least a majority (i.e., at least 50 weight percent) of any propadiene which might be present. In this embodiment, the propadiene would preferably be separated out in the second fraction along with DME. Preferably, at least about 75 weight percent, more preferably at least about 85 weight percent, and most preferably at least about 95 weight percent of the propadiene would be separated out. Separating out any propadiene in this manner would necessarily include separating out a substantial portion of any methyl acetylene which can also be present in the provided initial effluent stream. This is because methyl acetylene has a lower normal boiling point than propadiene and DME. Removing propadiene and methyl acetylene from the provided initial effluent stream would provide a substantial benefit in that the first fraction containing the ethylene and/or propylene would have a very high concentration of mono-olefinic compounds. Such a stream would need little if any hydro processing, which might typically be needed to reduce the number of multiply unsaturated or alkylene compounds recovered in the first fraction.

This separation technique is particularly advantageous for treating the ethylene and propylene streams contained in the first fraction to remove entrained acid gases such as CO2 which can also be present in such fraction. The advantage is that in this invention the separated ethylene and propylene streams will contain relatively few hydrocarbon components that cause fouling problems in such acid gas treatment systems.

Solid or liquid acid gas treatment systems can be used in this invention. In either system, the acid gas is removed from the ethylene and/or propylene stream in the first fraction by contacting the first fraction with an acid gas absorbent or adsorbent. Examples of such absorbents or adsorbents include amines, potassium carbonate, caustic, alumina, molecular sieves, and membranes, particularly membranes formed of polysulfone, polyimid, polyamide, glassy polymer and cellulose acetate. Solutions containing amines and caustic compounds are preferred, with caustic compounds being more preferred.

Aqueous amine solutions which are useful in this invention can contain any amine compound or compounds suitable for acid gas absorption. Examples include alkanolamines, such as triethanolamine (TEA); methyldiethanolamine (MDEA); diethanolamine (DEA); monoethanolamine (MEA); diisopropanolamine (DIPA); and hydroxyaminoethyl ether (DGA). Effective concentrations can range from about 0.5 to about 8 moles of amine per liter of aqueous solution.

Piperazine and/or monomethylethanolamine (MMEA) can be added to aqueous amine solutions to enhance their absorption capabilities. These additives can be included in the aqueous solution at a concentration of from about 0.04 to about 2 moles per liter of aqueous solution.

Caustic compounds which can be used in this invention are alkaline compounds which are effective in removing acid gas from an initial effluent stream. Examples of such alkaline compounds include sodium hydroxide and potassium hydroxide.

Following acid gas treating, it is desirable to remove additionally entrained material in the treated ethylene and/or propylene using a water wash. Conventional equipment can be used. It is desirable, however, to further remove additional water from the separated ethylene and/or propylene streams.

In one embodiment of this separation technique, the ethylene and propylene in the first fraction is water washed, i.e., contacted with a water stream, prior to acid gas treating. This contacting is particularly advantageous when water absorbent is added to the oxygenate separation vessel, e.g., the first separation unit, as water absorbent can carry over into the first or overhead fraction. Water washing would then be conducted to remove a substantial portion of water absorbent carry over prior to acid gas treating.

This invention further includes an optional drying embodiment. In this embodiment, a solid or liquid drying system can be used to remove water and/or additional oxygenated hydrocarbon from the first fraction.

In the solid drying system, the ethylene and/or propylene having been separated in a first fraction, and optionally acid gas treated and water washed, is contacted with a solid adsorbent to further remove water and oxygenated hydrocarbon to very low levels. Typically, the adsorption process is carried out in one or more fixed beds containing a suitable solid adsorbent.

Adsorption is useful for removing water and oxygenated hydrocarbons to very low concentrations, and for removing oxygenated hydrocarbons that are not normally removed by using other treatment systems. Preferably, an adsorbent system used as part of this invention has multiple adsorbent beds. Multiple beds allow for continuous separation without the need for shutting down the process to regenerate the solid adsorbent. For example, in a three bed system typically one bed is on-line, one bed is regenerated off-line, and a third bed is on stand-by.

The specific adsorbent solid or solids used in the adsorbent beds depends on the types of contaminants being removed. Examples of solid adsorbents for removing water and various polar organic compounds, such as oxygenated hydrocarbons and absorbent liquids, include aluminas, silica, 3 Å molecular sieves, 4 Å molecular sieves, and alumino-silicates. Beds containing mixtures of these sieves or multiple beds having different adsorbent solids can be used to remove water, as well as a variety of oxygenated hydrocarbons.

In this separation technique, one or more adsorption beds can be arranged in series or parallel. In one example of a series arrangement, a first bed is used to remove the smallest and most polar molecules which are the easiest to remove. Subsequent beds for removing larger less polar oxygenated species are next in series. As a specific example of one type of arrangement, water is first selectively removed using a 3 Å molecular sieve. This bed is then followed by one or more beds containing one or more less selective adsorbents such as a larger pore molecular sieve e.g. 13× and/or a high surface area active alumina such as Selexorb CD (Alcoa tradename).

In another embodiment, the first bed is a 3.6 Å molecular sieve capable of selectively removing both water and methanol. This bed can then be followed by one or more 13× or active alumina beds as described above.

The adsorbent beds can be operated at ambient temperature or at elevated temperature as required, and with either upward or downward flow. Regeneration of the adsorbent materials can be carried out by conventional methods including treatment with a stream of a dry inert gas such as nitrogen at elevated temperature.

In the liquid drying system, a water absorbent is used to remove water from the first fraction. The water absorbent can be any liquid effective in removing water from an olefin stream. Preferably, the water absorbent is the same as that previously described.

Preferably the olefin from the adsorption beds contains less than about 100 wppm water, more preferably less than about 10 wppm, and most preferably less than 1 wppm. Preferably less than about 10 wppm DME is present in the stream leaving the adsorption beds, more preferably less than about 5 wppm, and most preferably less than about 1 wppm.

U.S. patent applications No. 10/125,138, filed Apr. 18, 2002, and Ser. No. 10/124,859, filed on Apr. 18, 2002, the entireties of which are incorporated herein by reference, disclose particularly desirable first separation units that may be implemented in the separation processes for forming the propylene-containing composition of the present invention.

C2/C3 Separation

The effluent processing system also preferably includes a C2/C3 separation unit, which provides the propylene-containing composition of the present invention. In this embodiment, the first fraction from the first separation unit, described above, is directed to a second separation unit, e.g., a C2/C3 separation unit, for further processing. The second separation unit preferably subjects the first fraction to conditions, e.g., temperature and pressure, that are effective to separate the first fraction into a third fraction and a fourth fraction, e.g., the propylene containing composition. The third fraction, which preferably is an overhead fraction, contains a majority of the ethane and ethylene, individually or collectively, that was present in the first fraction. More preferably, the third fraction comprises at least about 60 weight percent, more preferably at least about 75 weight percent, and most preferably at least about 90 weight percent of the ethane and ethylene, individually or collectively, that was present in the first fraction. If the first fraction includes acetylene, then the third fraction preferably contains a majority of the acetylene that was present in the first fraction. More preferably, the third fraction comprises at least about 60 weight percent, more preferably at least about 75 weight percent, and most preferably at least about 90 weight percent of the acetylene that was present in the first fraction. The fourth fraction, which preferably is a bottoms fraction, contains a majority of the propylene that was present in the first fraction. More preferably, the fourth fraction comprises at least about 60 weight percent, more preferably at least about 75 weight percent, and most preferably at least about 90 weight percent of the propylene that was present in the first fraction. If the first fraction includes propane, then the fourth fraction preferably contains a majority of the propane that was present in the first fraction. More preferably, the fourth fraction comprises at least about 60 weight percent, more preferably at least about 75 weight percent, and most preferably at least about 90 weight percent of the propane that was present in the first fraction. The second separation unit preferably includes one or more distillation and/or fractionation columns, absorbers and/or extractive distillation columns that are designed to form one or more overhead streams comprising ethane and ethylene, and optionally acetylene, and one or more bottoms streams comprising propylene, and optionally propane.

The third fraction preferably is directed to one or more additional separation units for separation of the components contained therein, as described, for example, in co-pending U.S. patent application Ser. No. ______ [INSERT WHEN REC'D FROM U.S. PTO FOR Asset 415], filed on Aug. 6, 2003, the entirety of which is incorporated herein by reference, and in co-pending U.S. patent application Ser. No. 10/383,204, filed on Mar. 6, 2003, the entirety of which is also incorporated herein by reference.

The fourth fraction, e.g., the propylene-containing composition of the present invention, contains propylene suitable for polymerization, but also contains a minor amount of propane and DME. Optionally, the fourth fraction or a portion thereof, is directed to a propane purge tower, typically found in a polypropylene reaction system. The propane purge tower operates in a manner similar to a C3 splitter, which efficiently separates propane from propylene, although the propane purge tower includes fewer trays than a C3 splitter thereby providing a commensurate decrease in height and start-up costs. As a result, the propane purge tower is a distillation column adapted to separate some, but not all, of the propane and DME from the fourth fraction. The resulting propylene containing composition comprises propylene, propane and DME and possibly minor amounts of other contaminants, described in detail below. Additional undesired contaminants contained in the propylene-containing composition optionally are adsorbatively removed in an adsorption unit by contacting the propylene containing composition with a mole sieve or the like, under conditions effective to remove the contaminants therefrom.

DME is particularly difficult to remove from the initial effluent stream. One preferred embodiment for forming the propylene-containing composition of the invention includes partially removing DME from the initial effluent stream and allowing the remainder of DME to pass through the effluent processing system to the propylene-containing composition. In this embodiment, the first separation unit, described above, removes a first portion of DME from the initial effluent stream in the second fraction. A second portion of the DME from the initial effluent stream remains in the first fraction. Thus, both the first and second fractions contain a detectable amount of DME. In terms of lower range limitations, the first fraction may include at least about 5 weight percent, more preferably at least about 10 weight percent, more preferably at least about 20 weight percent, and most preferably at least about 60 weight percent of the DME that was present in the initial effluent stream. The second fraction may include at least about 5 weight percent, more preferably at least about 10 weight percent, more preferably at least about 20 weight percent, and most preferably at least about 30 weight percent of the DME that was present in the initial effluent stream. The DME remaining in the first fraction then passes through the second separation unit and into the fourth fraction. In one embodiment, the second fraction contains from about 10 weight percent to about 40 weight percent, more preferably from about 15 to about 35 weight percent, and most preferably from about 20 to about 30 weight percent of the DME that was present in the initial effluent stream. In this embodiment, the fourth fraction, e.g., the propylene containing composition, preferably contains from about 60 weight percent to about 90 weight percent, more preferably from about 65 to about 85 weight percent, and most preferably from about 70 to about 80 weight percent of the DME that was present in the initial effluent stream.

Acetylene and other multiply unsaturated species are generally undesirable compounds, which preferably are converted to a more desirable form in one or more hydrogenation converters, e.g., acetylene converters. The hydrogenation converters are adapted to at least partially saturate acetylene or other multiply unsaturated species to, for example, alkenes and/or alkanes. Specifically, in a hydrogenation converter, multiply unsaturated species such as acetylene contact hydrogen and/or carbon monoxide under conditions effective to at least partially hydrogenate the multiply unsaturated species. The one or more acetylene converters may be adapted to at least partially hydrogenate other components as well. A non-limiting list of other exemplary components that may be at least partially hydrogenated in a hydrogenation converter includes: methyl acetylene and propadiene. Preferably, the hydrogenation converter converts acetylene to ethylene; methyl acetylene to propylene; and propadiene to propylene. Desirable components such as ethylene and propylene preferably pass through the one or more hydrogenation converters unaltered. According to the present invention, the one or more hydrogenation converters may be oriented in a variety of locations, although the converters ideally are oriented along one or more streams that contain acetylene. In the separation sequence described above, the one or more hydrogenation converters preferably receives and processes multiply unsaturated species from the fourth fraction.

FIG. 1 illustrates one process for forming the propylene-containing composition of the present invention. As shown, initial effluent stream 101, which contains ethane, ethylene, DME, propane, and propylene is directed to first separation unit 102, which preferably is a distillation column adapted to separate ethylene and propylene, as well as lighter components, from the DME and heavier components, including any C4+ components, and methanol. This means that both ethylene and propylene are recoverable in a first fraction 104, with the DME and C4+ components being recoverable in a second fraction 105. Propane that is present in the initial effluent stream 101 is recoverable in either the first or second fraction, or both, depending upon how low a concentration of DME in the first fraction is desired. Additional methanol optionally is added to the first separation unit 102 though line 103 to reduce hydrate and/or free water formation in the first separation unit 102. The first separation unit 102 optionally includes a reflux line and/or a reboiler line and corresponding heat exchangers, not shown, to facilitate separation of these components. Specifically, the first separation unit 102 separates the initial effluent stream 101 into a first fraction 104, which contains a majority of the ethane, ethylene, propane and propylene that was present in the initial effluent stream 101 and a first portion of the DME present in the initial effluent stream 101, and a second fraction 105, which preferably contains a second portion, e.g., a majority, of the DME that was present in the initial effluent stream 101. The second fraction 105 also preferably contains a majority of the C4+ components and methanol, if any, that was present in the initial effluent stream 101.

Optionally, first fraction 104 is directed to a caustic wash unit to remove carbon dioxide, a water wash column, and/or a drying unit, not shown. Reverting to FIG. 1, first fraction 104 preferably is directed to a second separation unit 106. The second separation unit 106 preferably is a distillation column adapted to separate C2− components from C3+ components. Specifically, the second separation unit 106 separates the first fraction 104 into a third fraction 107, which contains a majority of the ethane and ethylene that was present in the first fraction 104, and a fourth fraction 108, which preferably contains a majority of the propane, propylene and DME that was present in the first fraction 104. The second separation unit 106 optionally includes a reflux line and/or a reboiler line and corresponding heat exchangers, not shown, to facilitate separation of the C2− components from the C3+ components.

If the initial effluent stream 101 contains acetylene, methyl acetylene, propadiene, or other multiply unsaturated components, then the effluent processing system preferably includes a hydrogenation converter, e.g., an acetylene converter, not shown. If incorporated into the present invention, the hydrogenation converter preferably receives and processes one or more of the following streams: the first fraction 104, the third fraction 107, and/or the fourth fraction 108. In the hydrogenation converter, acetylene contacts hydrogen and carbon dioxide under conditions effective to convert at least a portion of the acetylene to ethylene. Similarly, methyl acetylene and/or propadiene contact hydrogen and carbon dioxide under conditions effective to convert at least a portion of the methyl acetylene and/or propadiene to propylene. Components other than acetylene, methyl acetylene and propadiene that are present in the above-identified streams preferably pass unaltered through the hydrogenation converter(s).

The fourth fraction 108 is one propylene-containing composition of the present invention, which contains mostly propylene and a minor amount of propane and DME, and is well-suited for polymerization disposition. The fourth fraction 108 optionally is directed to a propane purge tower, not shown, for removal of some of the propane and DME from fourth fraction 108. Additionally or alternatively, fourth fraction 108 is directed to an adsorbtion unit, not shown, for selective removal of other undesired contaminants contained therein. A detailed description of the inventive propylene-containing composition is provided below.

Light Ends Removal Followed by C2/C3 Separation

In another embodiment of forming the propylene-containing composition of the present invention, light ends removal is followed by C2/C3 separation. In this embodiment, the first fraction from the first separation unit is directed to a second separation unit, which operates as a light ends removal unit. The second separation unit preferably subjects the first fraction to conditions, e.g., temperature and pressure, that are effective to separate the first fraction into a third fraction and a fourth fraction. The third fraction, which preferably is an overhead fraction, contains a majority of the light ends, individually or collectively, that were present in the first fraction. More preferably, the third fraction comprises at least about 60 weight percent, more preferably at least about 75 weight percent, and most preferably at least about 90 weight percent of the light ends, individually or collectively, that were present in the first fraction. The fourth fraction, which preferably is a bottoms fraction, contains a majority of the ethane, ethylene, propylene and DME individually or collectively, that was present in the first fraction. More preferably, the fourth fraction comprises at least about 60 weight percent, more preferably at least about 75 weight percent, and most preferably at least about 90 weight percent of the ethane, ethylene, propylene and DME, individually or collectively, that was present in the first fraction. If the first fraction contained propane and/or acetylene, the fourth fraction also preferably contains at least about 60 weight percent, more preferably at least about 75 weight percent, and most preferably at least about 90 weight percent of the propane and/or acetylene, individually or collectively, that was present in the first fraction. The second separation unit preferably includes one or more distillation and/or fractionation columns, absorbers and/or extractive distillation columns that are designed to form one or more overhead streams comprising the methane and other light ends, and one or more bottoms streams comprising the ethane, ethylene and propylene, and optionally propane and/or acetylene.

In this embodiment, the fourth fraction is directed to a third separation unit, e.g., a C2/C3 separation unit. The third separation unit preferably subjects the fourth fraction to conditions, e.g., temperature and pressure, that are effective to separate the fourth fraction into a fifth fraction and a sixth fraction. The fifth fraction, which preferably is an overhead fraction, contains a majority of the ethane and ethylene, individually or collectively, that was present in the fourth fraction. More preferably, the fifth fraction comprises at least about 60 weight percent, more preferably at least about 75 weight percent, and most preferably at least about 90 weight percent of the ethane and ethylene, individually or collectively, that was present in the fourth fraction. If the fourth fraction includes acetylene, then the fifth fraction preferably contains a majority of the acetylene that was present in the fourth fraction. More preferably, the fifth fraction comprises at least about 60 weight percent, more preferably at least about 75 weight percent, and most preferably at least about 90 weight percent of the acetylene that was present in the fourth fraction. The sixth fraction, which preferably is a bottoms fraction, contains a majority of the propylene and DME, individually or collectively, that was present in the fourth fraction. More preferably, the sixth fraction comprises at least about 60 weight percent, more preferably at least about 75 weight percent, and most preferably at least about 90 weight percent of the propylene and DME, individually or collectively, that was present in the fourth fraction. If the fourth fraction includes propane, then the sixth fraction preferably contains a majority of the propane that was present in the fourth fraction. More preferably, the sixth fraction comprises at least about 60 weight percent, more preferably at least about 75 weight percent, and most preferably at least about 90 weight percent of the propane that was present in the fourth fraction. The third separation unit preferably includes one or more distillation and/or fractionation columns, absorbers and/or extractive distillation columns that are designed to form one or more overhead streams comprising the ethane and ethylene, and optionally acetylene, and one or more bottoms streams comprising the propylene, DME and optionally propane.

The fifth fraction optionally is further processed to separate ethane from ethylene, as described in co-pending U.S. patent application Ser. No. ______ [INSERT WHEN REC'D FROM U.S. PTO FOR Asset 415], filed on ______ [insert], the entirety of which is incorporated herein by reference, and in co-pending U.S. patent application Ser. No. 10/383,204, filed on Mar. 6, 2003, the entirety of which is also incorporated herein by reference.

The sixth fraction is one propylene-containing composition according to the present invention, which contains propylene suitable for polymerization, but also contains a minor amount of propane and DME as well as additional contaminants, described in detail below. Optionally, the sixth fraction or a portion thereof, is directed to a propane purge tower, typically found in a polypropylene reaction system. The propane purge tower operates in a manner similar to a C3 splitter, which efficiently separates propane from propylene, although the propane purge tower includes fewer trays than a C3 splitter thereby providing a commensurate decrease in height and start-up costs. As a result, the propane purge tower is a distillation column adapted to separate some, but not all, of the propane and DME from the sixth fraction. The resulting propylene-containing composition comprises propylene, propane and DME and possibly minor amounts of other contaminants, described in detail below. Additional undesired contaminants contained in the propylene-containing composition optionally are adsorbatively removed in an adsorption unit by contacting the propylene-containing composition with a mole sieve or the like, under conditions effective to remove the contaminants therefrom.

As discussed above, DME is particularly difficult to remove from the initial effluent stream. One preferred embodiment includes partially removing DME from the initial effluent stream and allowing the remainder of the DME to pass through the effluent processing system to the propylene-containing composition. In this embodiment, the first separation unit, described above, removes a first portion of DME from the initial effluent stream in the second fraction. A second portion of the DME from the initial effluent stream remains in the first fraction. Thus, both the first and second fractions contain a detectable amount of DME. In terms of lower range limitations, the first fraction may include at least about 5 weight percent, more preferably at least about 10 weight percent, more preferably at least about 20 weight percent, and most preferably at least about 60 weight percent of the DME that was present in the initial effluent stream. The second fraction may include at least about 5 weight percent, more preferably at least about 10 weight percent, more preferably at least about 20 weight percent, and most preferably at least about 30 weight percent of the DME that was present in the initial effluent stream. The DME that remains in the first fraction then passes through the second separation unit, and the third separation unit via the fourth fraction. In one embodiment, the second fraction contains from about 10 weight percent to about 40 weight percent, more preferably from about 15 to about 35 weight percent, and most preferably from about 20 to about 30 weight percent of the DME that was present in the initial effluent stream. In this embodiment, the sixth fraction, e.g., the propylene-containing composition, preferably contains from about 60 weight percent to about 90 weight percent, more preferably from about 65 to about 85 weight percent, and most preferably from about 70 to about 80 weight percent of the DME that was present in the initial effluent stream.

In this embodiment of the present invention, the one or more hydrogenation converters may be oriented in a variety of locations, although the converters ideally are oriented along one or more streams that contain acetylene, methyl acetylene and/or propadiene. In the separation sequence described above, the one or more hydrogenation converters preferably receives and processes multiply unsaturated species from the first fraction, the fourth fraction, the fifth fraction and/or the sixth fraction, as these fractions contain the highest concentrations of these components.

FIG. 2 illustrates this embodiment for forming the propylene-containing composition of the present invention. As shown, initial effluent stream 201, which contains ethane, ethylene, DME, propane, and propylene is directed to first separation unit 202, which preferably is a distillation column adapted to separate ethylene and propylene and lighter components from the DME and heavier components, including any C4+ components, and methanol. Additional methanol optionally is added to the first separation unit 202 though line 203 to reduce hydrate and/or free water formation in the first separation unit 202. The first separation unit 202 optionally includes a reflux and/or a reboiler line, not shown, to facilitate separation of these components. Specifically, the first separation unit 202 separates the initial effluent stream 201 into a first fraction 204, which contains a majority of the ethane, ethylene, propane, propylene and a first portion of the DME that was present in the initial effluent stream 201, and a second fraction 205, which preferably contains a second portion, optionally a majority, of the DME that was present in the initial effluent stream 201. The second fraction 205 also preferably contains a majority of the C4+ components and methanol, if any, that was present in the initial effluent stream 201.

Optionally, first fraction 204 is directed to a caustic wash unit to remove carbon dioxide, a water wash column, and/or a drying unit, not shown. Reverting to FIG. 2, the first fraction 204 is then directed to demethanizer feed train 212. Demethanizer feed train 212 is a “cold box” that preferably is formed of a series of coolers, e.g., Core Exchangers, and knock out drums, not shown, that cool the first fraction 204 and form a plurality of cooled streams 214A-C. Cooled streams 214A-C may be in liquid and/or vapor form. Preferably, cooled streams 214A-C are directed to a second separation unit 215 for further processing. The second separation unit 215 preferably is a distillation column adapted to separate light ends such as methane, hydrogen and/or carbon monoxide from ethane, ethylene, propylene, propane and DME. Specifically, the second separation unit 215 separates the cooled streams 214A-C, collectively, into a third fraction 216, which contains a majority of the light components that were present in the cooled streams 214A-C, and a fourth fraction 217, which preferably contains a majority of the ethane, ethylene, propylene, propane and DME that was present in the cooled streams 214A-C. The second separation unit 215 optionally includes a reflux and/or a reboiler line, not shown, to facilitate separation of the light components from the ethane, ethylene, propylene, propane and DME. Third fraction 216 preferably is directed to the demethanizer feed train 212 for use as a cooling medium.

Fourth fraction 217 is directed to a third separation unit 206 for further processing. The third separation unit 206 preferably is a distillation column adapted to separate C2− components from C3+ components. Specifically, the second separation unit 206 separates the fourth fraction 217 into a fifth fraction 207, which contains a majority of the ethane and ethylene that was present in the fourth fraction 217, and a sixth fraction 208, which preferably contains a majority of the propane, propylene and DME that was present in the fourth fraction 217. The third separation unit 206 optionally includes a reflux and/or a reboiler line, not shown, to facilitate separation of the C2− components from the C3+ components. Fifth fraction 207 optionally is further processed to separate ethane from ethylene.

Sixth fraction 208 is one propylene-containing composition according to the present invention, which is well-suited for polymerization disposition, although the sixth fraction 208 may contain a minor amount of propane and DME. The sixth fraction 208 optionally is directed to a propane purge tower, not shown, for removal of some of the propane and DME from sixth fraction 208. Additionally or alternatively, sixth fraction 208 is directed to an adsorbtion unit, not shown, for selective removal of other undesired contaminants contained therein.

If the initial effluent stream 201 contains acetylene, methyl acetylene, propadiene, or other multiply unsaturated components, then the system of the present invention preferably includes a hydrogenation converter, e.g., an acetylene converter, not shown. If incorporated into the present invention, the hydrogenation converter preferably receives and processes one or more of the following streams: the first fraction 204, the fourth fraction 217, the fifth fraction 207, and/or the sixth fraction 208. In the hydrogenation converter, acetylene contacts hydrogen and carbon dioxide under conditions effective to convert at least a portion of the acetylene to ethylene. Similarly, methyl acetylene and/or propadiene contact hydrogen and carbon dioxide under conditions effective to convert at least a portion of the methyl acetylene and/or propadiene to propylene. Components other than acetylene, methyl acetylene and propadiene that are present in the above-identified streams preferably pass unaltered through the hydrogenation converter(s).

Propylene Containing Compositions

A detailed description of the propylene-containing composition according to the present invention will now be described in greater detail. In one embodiment, the propylene-containing composition of the present invention comprises at least 95 volume percent propylene, at least 0.5 volume percent propane, at least 10 vppm ethane, at least 1 vppm ethylene, and from 0.5 to 2 vppm dimethyl ether. It has been discovered that dimethyl ether, in the amounts found in the propylene-containing composition of the present invention, is not significantly detrimental to most polymerization catalysts.

Optionally, the propylene-containing composition includes additional contaminants. A non-limiting list of additional possible contaminants that may be present in the propylene-containing composition of the present invention, includes one or more of acetylene, methyl acetylene, propadiene, C4+hydrocarbons, methanol, water and hydrogen. Specifically, the propylene-containing composition of the present invention optionally comprises at least 0.05 vppm acetylene, or from 1 to 2 vppm acetylene. Optionally, the propylene-containing composition further comprises at least 0.01 vppm methyl acetylene, or from 1 to 3 vppm methyl acetylene. Optionally, the propylene-containing composition further comprises at least 0.01 vppm propadiene, or from 1 to 3 vppm propadiene. Optionally, the propylene-containing composition further comprises at least 0.02 vppm C4+ hydrocarbons, or from 5 to 15 vppm C4+ hydrocarbons. Optionally, the propylene-containing composition further comprises at least 0.01 vppm methanol, or from 0.5 to 1 vppm methanol. Optionally, the propylene containing composition further comprises at least 0.01 vppm water, or from 1 to 5 vppm water. Optionally, the propylene-containing composition further comprises at least 0.01 vppm hydrogen, or from 5 to 20 vppm hydrogen. Optionally, the propylene-containing composition comprises from 0.5 to 2 vppm methanol. Optionally, the propylene-containing composition comprises from 2 to about 5 volume percent propane. Optionally, the propylene-containing composition comprises from 300 to 1,000 vppm ethane. Optionally, the propylene-containing composition comprises from 5 to 15 vppm ethylene. Optionally, the propylene-containing composition comprises from 0.5 to 1 vppm dimethyl ether, or from 1 to 2 vppm dimethyl ether. Preferably, the propylene-containing composition is depleted, or substantially depleted, of arsine and phosphine. In one embodiment, the propylene-containing composition comprises less than 0.01 vppm arsine, preferably less than 0.001 vppm arsine. Preferably, the propylene-containing composition comprises less than 0.01 vppm phosphine, more preferably less than 0.001 vppm phosphine.

In another embodiment of the present invention, the propylene-containing composition comprises at least 95 volume percent propylene, from 0.5 to about 5 volume percent propane, at least 0.02 vppm C4+ hydrocarbons, at least 0.01 vppm methanol, and from 0.5 vppm to 2 vppm dimethyl ether. Optionally, the propylene-containing composition of this embodiment further comprises one or more of ethane, ethylene, propane, arsine, phosphine, acetylene, methyl acetylene, water, hydrogen and/or propadiene, optionally in the amounts provided in the above ranges.

In another embodiment, the present invention provides a propylene-containing composition comprising at least 95 volume percent propylene, from 0.5 to 5 volume percent propane, at least 10 vppm ethane, at least 0.05 vppm acetylene, and from 0.5 to 2 vppm dimethyl ether. Optionally, the propylene-containing composition of this embodiment further comprises one or more of ethylene, C4+ hydrocarbons, methanol, arsine, phosphine, methyl acetylene, water, hydrogen and/or propadiene, optionally in the amounts provided in the above ranges.

In another embodiment, the present invention is directed to a propylene-containing composition comprising at least 95 volume percent propylene, from 0.5 to about 5 volume percent propylene, at least 10 vppm ethane, at least 0.02 vppm C4+ hydrocarbons, and from 0.5 to 2 vppm dimethyl ether. Optionally, the propylene-containing composition of this embodiment further comprises one or more of ethylene, acetylene, methanol, arsine, phosphine, methyl acetylene, water, hydrogen and/or propadiene, optionally in the amounts provided in the above ranges.

In another embodiment, the present invention is directed to a propylene-containing composition comprising at least 95 volume percent propylene, from 0.5 to 5 volume percent propane, at least 0.1 vppm water, at least 0.01 vppm methanol, and from 0.5 to 2 vppm dimethyl ether. Optionally, the propylene-containing composition of this embodiment further comprises one or more of ethane, ethylene, C4+ hydrocarbons, acetylene, arsine, phosphine, methyl acetylene, hydrogen and/or propadiene, optionally in the amounts provided in the above ranges.

In another embodiment, the present invention is directed to a propylene-containing composition, wherein the composition is formed by a specified process. The process preferably includes a step of contacting an oxygenate with a molecular sieve catalyst in a reactor under conditions effective to form an effluent stream comprising propylene, propane, ethylene, dimethyl ether and ethane. The effluent stream is separated in a first separation unit into a first fraction and a second fraction. The first fraction contains a majority of the ethane, ethylene and propylene, and the second fraction contains a majority of the dimethyl ether. At least a portion of the first fraction is separated into a third fraction and the propylene-containing composition. The third fraction contains the majority of the ethylene and ethane in the at least a portion of the first fraction. The propylene-containing composition comprises at least 95 volume percent propylene, at least 0.5 volume percent propane, at least 10 vppm ethane, at least 1 vppm ethylene and from 0.5 to 2 vppm dimethyl ether. In this embodiment, the conditions in the contacting step optionally provide for 95 to 97 weight percent conversion of the oxygenate, based on the total weight of the oxygenate fed to the reactor. The contacting optionally occurs at a pressure of at least 150 psig, a pressure of from 150 to 370 psig, or a pressure of from 250 to 370 psig.

In another embodiment, the present invention is directed to a propylene-containing composition, which is formed by a process comprising an initial C2/C3 separation step. This process also comprises a step of contacting an oxygenate with a molecular sieve catalyst in a reactor under conditions effective to form an effluent stream comprising propylene, propane, ethylene, DME and ethane. The effluent stream is separated in a first separation unit into a first fraction and a second fraction. In this process, the first fraction contains a majority of the ethane and ethylene and, the second fraction contains a majority of the DME, propane and propylene. At least a portion of the second fraction is separated into the propylene-containing composition and a third fraction. In this embodiment, the propylene-containing composition comprises at least 95 volume percent propylene, at least 0.5 volume percent propane, at least 10 vppm ethane, at least 1 vppm ethylene, and from 0.5 to 2 vppm DME. The third fraction contains a majority of the propane and DME present in the at least a portion of the second fraction.

The MTO Reaction Process

As discussed above, the present invention is particularly suited for deriving the propylene-containing composition of the present invention from an MTO reaction system, which is discussed in more detail hereinafter.

Typically, molecular sieve catalysts have been used to convert oxygenate compounds to light olefins. Silicoaluminophosphate (SAPO) molecular sieve catalysts are particularly desirable in such a conversion process, because they are highly selective in the formation of ethylene and propylene. A non-limiting list of preferable SAPO molecular sieve catalysts includes SAPO-17, SAPO-18, SAPO-34, SAPO-35, SAPO-44, the substituted forms thereof, and mixtures thereof. The molecular sieve catalyst optionally comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

The feedstock preferably contains one or more aliphatic-containing compounds that include alcohols, amines, carbonyl compounds for example aldehydes, ketones and carboxylic acids, ethers, halides, mercaptans, sulfides, and the like, and mixtures thereof. The aliphatic moiety of the aliphatic-containing compounds typically contains from 1 to about 50 carbon atoms, preferably from 1 to 20 carbon atoms, more preferably from 1 to 10 carbon atoms, and most preferably from 1 to 4 carbon atoms.

Non-limiting examples of aliphatic-containing compounds include: alcohols such as methanol and ethanol, alkyl-mercaptans such as methyl mercaptan and ethyl mercaptan, alkyl-sulfides such as methyl sulfide, alkyl-amines such as methyl amine, alkyl-ethers such as DME, diethyl ether and methylethyl ether, alkyl-halides such as methyl chloride and ethyl chloride, alkyl ketones such as dimethyl ketone, alkyl-aldehydes such as formaldehyde and acetaldehyde, and various acids such as acetic acid.

In a preferred embodiment of the process of the invention, the feedstock contains one or more oxygenates, more specifically, one or more organic compound(s) containing at least one oxygen atom. In the most preferred embodiment of the process of invention, the oxygenate in the feedstock is one or more alcohol(s), preferably aliphatic alcohol(s) where the aliphatic moiety of the alcohol(s) has from 1 to 20 carbon atoms, preferably from 1 to 10 carbon atoms, and most preferably from 1 to 4 carbon atoms. The alcohols useful as feedstock in the process of the invention include lower straight and branched chain aliphatic alcohols and their unsaturated counterparts. Non-limiting examples of oxygenates include methanol, ethanol, n-propanol, isopropanol, methyl ethyl ether, DME, diethyl ether, di-isopropyl ether, formaldehyde, dimethyl carbonate, dimethyl ketone, acetic acid, and mixtures thereof. In the most preferred embodiment, the feedstock is selected from one or more of methanol, ethanol, DME, diethyl ether or a combination thereof, more preferably methanol and DME, and most preferably methanol.

The various feedstocks discussed above, particularly a feedstock containing an oxygenate, more particularly a feedstock containing an alcohol, is converted primarily into one or more olefin(s). The olefin(s) or olefin monomer(s) produced from the feedstock typically have from 2 to 30 carbon atoms, preferably 2 to 8 carbon atoms, more preferably 2 to 6 carbon atoms, still more preferably 2 to 4 carbons atoms, and most preferably ethylene an/or propylene.

Non-limiting examples of olefin monomer(s) include ethylene, propylene, butene-1, pentene-1,4-methyl-pentene-1, hexene-1, octene-1 and decene-1, preferably ethylene, propylene, butene-1, pentene-1,4-methyl-pentene-1, hexene-1, octene-1 and isomers thereof. Other olefin monomer(s) include unsaturated monomers, diolefins having 4 to 18 carbon atoms, conjugated or nonconjugated dienes, polyenes, vinyl monomers and cyclic olefins.

In the most preferred embodiment, the feedstock, preferably of one or more oxygenates, is converted in the presence of a molecular sieve catalyst composition into olefin(s) having 2 to 6 carbons atoms, preferably 2 to 4 carbon atoms. Most preferably, the olefin(s), alone or combination, are converted from a feedstock containing an oxygenate, preferably an alcohol, most preferably methanol, to the preferred olefin(s) ethylene and/or propylene.

The most preferred process is generally referred to as gas-to-olefins (GTO) or alternatively, methanol-to-olefins (MTO). In an MTO process, a methanol containing feedstock, is converted in the presence of a molecular sieve catalyst composition into one or more olefins, preferably and predominantly, ethylene and/or propylene, often referred to as light olefins.

The feedstock, in one embodiment, contains one or more diluents, typically used to reduce the concentration of the feedstock. The diluents are generally non-reactive to the feedstock or molecular sieve catalyst composition. Non-limiting examples of diluents include helium, argon, nitrogen, carbon monoxide, carbon dioxide, water, essentially non-reactive paraffins (especially alkanes such as methane, ethane, and propane), essentially non-reactive aromatic compounds, and mixtures thereof. The most preferred diluents are water and nitrogen, with water being particularly preferred. In other embodiments, the feedstock does not contain any diluent.

The diluent may be used either in a liquid or a vapor form, or a combination thereof. The diluent is either added directly to a feedstock entering into a reactor or added directly into a reactor, or added with a molecular sieve catalyst composition. In one embodiment, the amount of diluent in the feedstock is in the range of from about 1 to about 99 mole percent based on the total number of moles of the feedstock and diluent, preferably from about 1 to 80 mole percent, more preferably from about 5 to about 50, most preferably from about 5 to about 25. In one embodiment, other hydrocarbons are added to a feedstock either directly or indirectly, and include olefin(s), paraffin(s), aromatic(s) (see for example U.S. Pat. No. 4,677,242, addition of aromatics) or mixtures thereof, preferably propylene, butylene, pentylene, and other hydrocarbons having 4 or more carbon atoms, or mixtures thereof.

The process for converting a feedstock, especially a feedstock containing one or more oxygenates, in the presence of a molecular sieve catalyst composition of the invention, is carried out in a reaction process in a reactor, where the process is a fixed bed process, a fluidized bed process (includes a turbulent bed process), preferably a continuous fluidized bed process, and most preferably a continuous high velocity fluidized bed process.

The reaction processes can take place in a variety of catalytic reactors such as hybrid reactors that have a dense bed or fixed bed reaction zones and/or fast fluidized bed reaction zones coupled together, circulating fluidized bed reactors, riser reactors, and the like. Suitable conventional reactor types are described in for example U.S. Pat. No. 4,076,796, U.S. Pat. No. 6,287,522 (dual riser), and Fluidization Engineering, D. Kunii and O. Levenspiel, Robert E. Krieger Publishing Company, New York, N.Y. 1977, which are all herein fully incorporated by reference.

The preferred reactor type are riser reactors generally described in Riser Reactor, Fluidization and Fluid-Particle Systems, pages 48 to 59, F. A. Zenz and D. F. Othmer, Reinhold Publishing Corporation, New York, 1960, and U.S. Pat. No. 6,166,282 (fast-fluidized bed reactor), and U.S. patent application Ser. No. 09/564,613 filed May 4, 2000 (multiple riser reactor), which are all herein fully incorporated by reference.

In an embodiment, the amount of liquid feedstock fed separately or jointly with a vapor feedstock, to a reactor system is in the range of from 0.1 weight percent to about 85 weight percent, preferably from about 1 weight percent to about 75 weight percent, more preferably from about 5 weight percent to about 65 weight percent based on the total weight of the feedstock including any diluent contained therein. The liquid and vapor feedstocks are preferably the same composition, or contain varying proportions of the same or different feedstock with the same or different diluent.

The conversion temperature employed in the conversion process, specifically within the reactor system, is in the range of from about 392° F. (200° C.) to about 1832° F. (1000° C.), preferably from about 482° F. (250° C.) to about 1472° F. (800° C.), more preferably from about 482° F. (250° C.) to about 1382° F. (750° C.), yet more preferably from about 572° F. (300° C.) to about 1202° F. (650° C.), yet even more preferably from about 662° F. (350° C.) to about 1112° F. (600° C.) most preferably from about 662° F. (350° C.) to about 1022° F. (550° C.).

The conversion pressure employed in the conversion process, specifically within the reactor system, varies over a wide range including autogenous pressure. The conversion pressure is based on the partial pressure of the feedstock exclusive of any diluent therein. Typically the conversion pressure employed in the process is in the range of from about 0.1 kPaa to about 5 MPaa, preferably from about 5 kPaa to about 1 MPaa, and most preferably from about 20 kPaa to about 500 kPaa.

The weight hourly space velocity (WHSV), particularly in a process for converting a feedstock containing one or more oxygenates in the presence of a molecular sieve catalyst composition within a reaction zone, is defined as the total weight of the feedstock excluding any diluents to the reaction zone per hour per weight of molecular sieve in the molecular sieve catalyst composition in the reaction zone. The WHSV is maintained at a level sufficient to keep the catalyst composition in a fluidized state within a reactor.

Typically, the WHSV ranges from about 1 hr-1 to about 5000 hr-1, preferably from about 2 hr-1 to about 3000 hr-1, more preferably from about 5 hr-1 to about 1500 hr-1, and most preferably from about 10 hr-1 to about 1000 hr-1. In one preferred embodiment, the WHSV is greater than 20 hr-1, preferably the WHSV for conversion of a feedstock containing methanol, DME, or both, is in the range of from about 20 hr-i to about 300 hr-1.

The superficial gas velocity (SGV) of the feedstock including diluent and reaction products within the reactor system is preferably sufficient to fluidize the molecular sieve catalyst composition within a reaction zone in the reactor. The SGV in the process, particularly within the reactor system, more particularly within the riser reactor(s), is at least about 0.1 meter per second (m/sec), preferably greater than 0.5 m/sec, more preferably greater than 1 m/sec, even more preferably greater than 2 m/sec, yet even more preferably greater than 3 m/sec, and most preferably greater than 4 m/sec. See for example U.S. patent application Ser. No. 09/708,753 filed Nov. 8, 2000, which is herein incorporated by reference.

Propylene Disposition

The propylene-containing composition of the present invention is particularly well-suited to be polymerized to form plastic compositions, e.g., polyolefins, particularly polypropylene. Any conventional process for forming polypropylene can be used. Catalytic processes are preferred. Particularly preferred are metallocene, Ziegler/Natta, aluminum oxide and acid catalytic systems. See, for example, U.S. Pat. Nos. 3,258,455; 3,305,538; 3,364,190; 5,892,079; 4,659,685; 4,076,698; 3,645,992; 4,302,565; and 4,243,691, the catalyst and process descriptions of each being expressly incorporated herein by reference. In general, these methods involve contacting the propylene product with a polypropylene-forming catalyst at a pressure and temperature effective to form the polypropylene product.

In one embodiment of this invention, the propylene product is contacted with a metallocene catalyst to form polypropylene. Desirably, the polypropylene forming process is carried out at a temperature ranging between about 50° C. and about 320° C. The reaction can be carried out at low, medium or high pressure, being anywhere within the range of about 1 bar to about 3200 bar. For processes carried out in solution, an inert diluent can be used. In this type of operation, it is desirable that the pressure be at a range of from about 10 bar to about 150 bar, and preferably at a temperature range of from about 120° C. to about 250° C. For gas phase processes, it is preferred that the temperature generally be within a range of about 60° C. to 120° C., and that the operating pressure be from about 5 bar to about 50 bar.

In addition to polypropylene, numerous other olefin derivatives can be formed from the propylene-containing composition according to this invention. The propylene separated according to this invention can also be used in the manufacture of such compounds as aldehydes, acids such as C2-C13 mono carboxylic acids, alcohols such as C2-C12 mono alcohols, esters made from the C2-C12 mono carboxylic acids and the C2-C12 mono alcohols, linear alpha olefins, vinyl acetate, ethylene dicholoride and vinyl chloride, ethylbenzene, ethylene oxide, cumene, acrolein, allyl chloride, propylene oxide, acrylic acid, ethylene-propylene rubbers, and acrylonitrile, and trimers and dimers of ethylene and propylene. The C4+ olefins, butylene in particular, are particularly suited for the manufacture of aldehydes, acids, alcohols, esters made from C5-C13 mono carboxylic acids and C5-C13 mono alcohols and linear alpha olefins.

Having now fully described the invention, it will be appreciated by those skilled in the art that the invention may be performed within a wide range of parameters within what is claimed, without departing from the spirit and scope of the invention.

1. A propylene-containing composition, comprising:
(a) at least 95 volume percent propylene;
(b) at least 0.5 volume percent propane;
(c) at least 10 vppm ethane;
(d) at least 1 vppm ethylene; and
(e) from 0.5 to 2 vppm dimethyl ether.

2. The composition of claim 1, wherein the composition further comprises:
(f) at least 0.05 vppm acetylene.

3. The composition of claim 2, wherein the composition further comprises:
(g) from 1 to 2 vppm acetylene.

4. The composition of claim 3, wherein the composition further comprises:
(h) from 1 to 3 vppm methyl acetylene.

5. The composition of claim 4, wherein the composition further comprises:
(i) from 1 to 3 vppm propadiene.

6. The composition of claim 5, wherein the composition further comprises:
(j) from 5 to 15 vppm C4+ hydrocarbons.

7. The composition of claim 6, wherein the composition further comprises:
(k) from 0.5 to 1 vppm methanol.

8. The composition of claim 7, wherein the composition further comprises:
(l) from 1 to 5 vppm water.

9. The composition of claim 8, wherein the composition further comprises:
(m) from 5 to 20 vppm hydrogen.

10. The composition of claim 1, wherein the composition further comprises:
(f) at least 0.01 vppm methyl acetylene.

11. The composition of claim 1, wherein the composition further comprises:
(f) at least 0.01 vppm propadiene.

12. The composition of claim 1, wherein the composition further comprises:
(f) at least 0.02 vppm C4+ hydrocarbons.

13. The composition of claim 1, wherein the composition further comprises:
(f) at least 0.01 vppm methanol.

14. The composition of claim 1, wherein the composition further comprises:
(f) at least 0.01 vppm water.

15. The composition of claim 1, wherein the composition further comprises:
(f) at least 0.01 vppm hydrogen.

16. The composition of claim 1, wherein the composition comprises from 2 to about 5 volume percent propane.

17. The composition of claim 1, wherein the composition comprises from 300 to 1000 vppm ethane.

18. The composition of claim 1, wherein the composition comprises from 5 to 15 vppm ethylene.

19. The composition of claim 1, wherein the composition comprises from 1 to 3 vppm methyl acetylene.

20. The composition of claim 1, wherein the composition comprises from 1 to 3 vppm propadiene.

21. The composition of claim 1, wherein the composition comprises from 5 to 15 vppm C4+ hydrocarbons.

22. The composition of claim 1, wherein the composition comprises from 0.5 to 2 vppm methanol.

23. The composition of claim 1, wherein the composition comprises from 1 to 5 vppm water.

24. The composition of claim 1, wherein the composition comprises from 5 to 20 vppm hydrogen.

25. The composition of claim 1, wherein the composition comprises from 0.5 to 1 vppm dimethyl ether.

26. The composition of claim 1, wherein the composition comprises from 1 to 2 vppm dimethyl ether.

27. The composition of claim 1, wherein the composition comprises less than 0.01 vppm arsine.

28. The composition of claim 1, wherein the composition comprises less than 0.01 vppm phosphine.

29. The composition of claim 1, wherein the composition is suitable for polymerization.

30. A propylene-containing composition, comprising:
(a) at least 95 volume percent propylene;
(b) from 0.5 to about 5 volume percent propane;
(c) at least 0.02 vppm C4+ hydrocarbons;
(d) at least 0.01 vppm methanol; and
(e) from 0.5 vppm to 2 vppm dimethyl ether.

31. The composition of claim 30, wherein the composition comprises from 2.0 to about 5.0 volume percent propane.

32. The composition of claim 30, wherein the composition comprises from 5 to 15 vppm C4+ hydrocarbons.

33. The composition of claim 30, wherein the composition comprises from 0.5 to 1 vppm dimethyl ether.

34. The composition of claim 30, wherein the composition comprises from 1 to 2 vppm dimethyl ether.

35. The composition of claim 30, wherein the composition comprises less than 0.01 vppm arsine.

36. The composition of claim 30, wherein the composition comprises less than 0.01 vppm phosphine.

37. The composition of claim 30, wherein the composition is suitable for polymerization.

38. A propylene-containing composition, comprising:
(a) at least 95 volume percent propylene;
(b) from 0.5 to about 5 volume percent propane;
(c) at least 10 vppm ethane;
(d) at least 0.05 vppm acetylene; and
(e) from 0.5 to 2 vppm dimethyl ether.

39. The composition of claim 38, wherein the composition comprises from 2.0 to about 5 volume percent propane.

40. The composition of claim 38, wherein the composition comprises from 300 to 1000 vppm ethane.

41. The composition of claim 38, wherein the composition comprises from 1 to 2 vppm acetylene.

42. The composition of claim 38, wherein the composition comprises from 0.5 to 1 vppm dimethyl ether.

43. The composition of claim 38, wherein the composition comprises from 1 to 2 vppm dimethyl ether.

44. The composition of claim 38, wherein the composition comprises less than 0.01 vppm arsine.

45. The composition of claim 38, wherein the composition comprises less than 0.01 vppm phosphine.

46. The composition of claim 38, wherein the composition is suitable for polymerization.

47. A propylene-containing composition, comprising:
(a) at least 95 volume percent propylene;
(b) from 0.5 to about 5 volume percent propane;
(c) at least 10 vppm ethane;
(d) at least 0.02 vppm C4+ hydrocarbons; and
(e) from 0.5 to 2 vppm dimethyl ether.

48. The composition of claim 47, wherein the composition comprises from 2.0 to about 5 volume percent propane.

49. The composition of claim 47, wherein the composition comprises from 300 to 1000 vppm ethane.

50. The composition of claim 47, wherein the composition comprises from 5 to 15 vppm C4+ hydrocarbons.

51. The composition of claim 47, wherein the composition comprises from 0.5 to 1 vppm dimethyl ether.

52. The composition of claim 47, wherein the composition comprises from 1 to 2 vppm dimethyl ether.

53. The composition of claim 47, wherein the composition comprises less than 0.01 vppm arsine.

54. The composition of claim 47, wherein the composition comprises less than 0.01 vppm phosphine.

55. The composition of claim 47, wherein the composition is suitable for polymerization.

56. A propylene-containing composition, comprising:
(a) at least 95 volume percent propylene;
(b) from 0.5 to about 5 volume percent propane;
(c) at least 0.01 vppm water;
(d) at least 0.01 vppm methanol; and
(e) from 0.5 to 2 vppm dimethyl ether.

57. The composition of claim 56, wherein the composition comprises from 2.0 to about 5 volume percent propane.

58. The composition of claim 56, wherein the composition comprises from 1 to 5 vppm water.

59. The composition of claim 56, wherein the composition comprises from 0.5 to 1 wppm methanol.

60. The composition of claim 56, wherein the composition comprises from 0.5 to 1 vppm dimethyl ether.

61. The composition of claim 56, wherein the composition comprises from 1 to 2 vppm dimethyl ether.

62. The composition of claim 56, wherein the composition comprises less than 0.01 vppm arsine.

63. The composition of claim 56, wherein the composition comprises less than 0.01 vppm phosphine.

64. The composition of claim 56, wherein the composition is suitable for polymerization.

65. A propylene-containing composition, wherein the composition is formed by a process comprising the steps of:
(a) contacting an oxygenate with a molecular sieve catalyst in a reactor under conditions effective to form an effluent stream comprising propylene, propane, ethylene, dimethyl ether and ethane;
(b) separating the effluent stream in a first separation unit into a first fraction and a second fraction, wherein the first fraction contains a majority of the ethane, ethylene and propylene, and wherein the second fraction contains a majority of the dimethyl ether; and
(c) separating at least a portion of the first fraction into a third fraction and the propylene-containing composition, wherein the third fraction contains a majority of the ethylene and ethane present in the at least a portion of the first fraction, and wherein the propylene-containing composition comprises at least 95 volume percent propylene, at least 0.5 volume percent propane, at least 10 vppm ethane, at least 1 vppm ethylene, and from 0.5 to 2 vppm dimethyl ether.

66. The composition of claim 65, wherein the conditions in step (a) provide for 95 to 97 weight percent conversion of the oxygenate, based on the total weight of the oxygenate fed to the reactor.

67. The composition of claim 65, wherein step (b) occurs at a pressure of at least 150 psig.

68. The composition of claim 67, wherein the pressure is from 150 to 370 psig.

69. The composition of claim 68, wherein the pressure is from 250 to 370 psig.

70. The composition of claim 65, wherein the molecular sieve catalyst comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

71. The composition of claim 65, wherein the composition further comprises at least 0.05 vppm acetylene.

72. The composition of claim 71, wherein the composition further comprises from 1 to 2 vppm acetylene.

73. The composition of claim 72, wherein the composition further comprises from 1 to 3 vppm methyl acetylene.

74. The composition of claim 73, wherein the composition further comprises from 1 to 3 vppm propadiene.

75. The composition of claim 74, wherein the composition further comprises from 5 to 15 vppm C4+ hydrocarbons.

76. The composition of claim 75, wherein the composition further comprises from 0.5 to 1 vppm methanol.

77. The composition of claim 76, wherein the composition further comprises from 1 to 5 vppm water.

78. The composition of claim 77, wherein the composition further comprises from 5 to 20 vppm hydrogen.

79. The composition of claim 65, wherein the composition further comprises at least 0.01 vppm methyl acetylene.

80. The composition of claim 65, wherein the composition further comprises at least 0.01 vppm propadiene.

81. The composition of claim 65, wherein the composition further comprises at least 0.02 vppm C4+ hydrocarbons.

82. The composition of claim 65, wherein the composition further comprises at least 0.01 vppm methanol.

83. The composition of claim 65, wherein the composition further comprises at least 0.01 vppm water.

84. The composition of claim 65, wherein the composition further comprises at least 0.01 vppm hydrogen.

85. The composition of claim 65, wherein the composition comprises from 2 to about 5 volume percent propane.

86. The composition of claim 65, wherein the composition comprises from 300 to 1000 vppm ethane.

87. The composition of claim 65, wherein the composition comprises from 5 to 15 vppm ethylene.

88. The composition of claim 65, wherein the composition comprises from 1 to 2 vppm acetylene.

89. The composition of claim 65, wherein the composition comprises from 1 to 3 vppm methyl acetylene.

90. The composition of claim 65, wherein the composition comprises from 1 to 3 vppm propadiene.

91. The composition of claim 65, wherein the composition comprises from 5 to 15 vppm C4+ hydrocarbons.

92. The composition of claim 65, wherein the composition comprises from 0.5 to 1 vppm methanol.

93. The composition of claim 65, wherein the composition comprises from 1 to 5 vppm water.

94. The composition of claim 65, wherein the composition comprises from 5 to 20 vppm hydrogen.

95. The composition of claim 65, wherein the composition comprises from 0.5 to 1 vppm dimethyl ether.

96. The composition of claim 65, wherein the composition comprises from 1 to 2 vppm dimethyl ether.

97. The composition of claim 65, wherein the composition comprises less than 0.01 vppm arsine.

98. The composition of claim 65, wherein the composition comprises less than 0.01 vppm phosphine.

99. The composition of claim 65, wherein the propylene containing composition is suitable for polymerization.

100. A propylene-containing composition, wherein the composition is formed by a process comprising the steps of:
(a) contacting an oxygenate with a molecular sieve catalyst in a reactor under conditions effective to form an effluent stream comprising propylene, propane, ethylene, DME and ethane;
(b) separating the effluent stream in a first separation unit into a first fraction and a second fraction, wherein the first fraction contains a majority of the ethane and ethylene, and wherein the second fraction contains a majority of the DME, propane and propylene; and
(c) separating at least a portion of the second fraction into the propylene-containing composition and a third fraction wherein the propylene-containing composition comprises at least 95 volume percent propylene, at least 0.5 volume percent propane, at least 10 vppm ethane, at least 1 vppm ethylene, and from 0.5 to 2 vppm DME, and wherein the third fraction contains a majority of the propane and DME present in the second fraction.

101. The composition of claim 100, wherein the conditions in step (a) provide for 95 to 97 weight percent conversion of the oxygenate, based on the total weight of the oxygenate fed to the reactor.

102. The composition of claim 100, wherein the molecular sieve catalyst comprises a molecular sieve selected from the group consisting of SAPO-5, SAPO-8, SAPO-11, SAPO-16, SAPO-17, SAPO-18, SAPO-20, SAPO-31, SAPO-34, SAPO-35, SAPO-36, SAPO-37, SAPO-40, SAPO-41, SAPO-42, SAPO-44, SAPO-47, SAPO-56, AEI/CHA intergrowths, metal containing forms thereof, intergrown forms thereof, and mixtures thereof.

103. The composition of claim 100, wherein the composition further comprises at least 0.05 vppm acetylene.

104. The composition of claim 103, wherein the composition further comprises from 1 to 2 vppm acetylene.

105. The composition of claim 104, wherein the composition further comprises from 1 to 3 vppm methyl acetylene.

106. The composition of claim 105, wherein the composition further comprises from 1 to 3 vppm propadiene.

107. The composition of claim 106, wherein the composition further comprises from 5 to 15 vppm C4+ hydrocarbons.

108. The composition of claim 107, wherein the composition further comprises from 0.5 to 1 vppm methanol.

109. The composition of claim 108, wherein the composition further comprises from 1 to 5 vppm water.

110. The composition of claim 109, wherein the composition further comprises from 5 to 20 vppm hydrogen.

111. The composition of claim 100, wherein the composition further comprises at least 0.01 vppm methyl acetylene.

112. The composition of claim 100, wherein the composition further comprises at least 0.01 vppm propadiene.

113. The composition of claim 100, wherein the composition further comprises at least 0.02 vppm C4+ hydrocarbons.

114. The composition of claim 100, wherein the composition further comprises at least 0.01 vppm methanol.

115. The composition of claim 100, wherein the composition further comprises at least 0.01 vppm water.

116. The composition of claim 100, wherein the composition further comprises at least 0.01 vppm hydrogen.

117. The composition of claim 100, wherein the composition comprises from 2 to about 5 volume percent propane.

118. The composition of claim 100, wherein the composition comprises from 300 to 1000 vppm ethane.

119. The composition of claim 100, wherein the composition comprises from 5 to 15 vppm ethylene.

120. The composition of claim 100, wherein the composition comprises from 1 to 2 vppm acetylene.

121. The composition of claim 100, wherein the composition comprises from 1 to 3 vppm methyl acetylene.

122. The composition of claim 100, wherein the composition comprises from 1 to 3 vppm propadiene.

123. The composition of claim 100, wherein the composition comprises from 5 to 15 vppm C4+ hydrocarbons.

124. The composition of claim 100, wherein the composition comprises from 0.5 to 1 vppm methanol.

125. The composition of claim 100, wherein the composition comprises from 1 to 5 vppm water.

126. The composition of claim 100, wherein the composition comprises from 5 to 20 vppm hydrogen.

127. The composition of claim 100, wherein the composition comprises from 0.5 to 1 vppm DME.

128. The composition of claim 100, wherein the composition comprises from 1 to 2 vppm DME.

129. The composition of claim 100, wherein the composition comprises less than 0.01 vppm arsine.

130. The composition of claim 100, wherein the composition comprises less than 0.01 vppm phosphine.

131. The composition of claim 100, wherein the composition is suitable for polymerization.
